(19) United States
(12) Patent Application Publication
(10) Pub. No.: US 2004/0088723 A1
(43) Pub. Date: May 6, 2004

(54) Systems and methods for generating a video summary

(76) Inventors: Yu-Fei Ma, Beijing (CN); Lie Lu, Beijing (CN); Hong-Jiang Zhang, Beijing (CN); Mingjing Li, Beijing (CN)

Correspondence Address: LEE & HAYES PLLC, 421 W RIVERSIDE AVENUE SUITE 500, SPOKANE, WA, 99201

(21) Appl. No.: 10/286,527

(22) Filed: Nov. 1, 2002

(51) Int. Cl. H04N 7/16; G06K 9/56; G06K 9/46; G06K 9/66; G06K 9/00; H04H 9/00

(52) U.S. Cl. 725/19; 382/181; 382/195; 382/205; 382/190; 725/9

(57) ABSTRACT

Systems and methods to generate a video summary of a video data sequence are described. In one aspect, key-frames of the video data sequence are identified independent of shot boundary detection. A static summary of shots in the video data sequence is then generated based on key-frame importance. For each shot in the static summary of shots, dynamic video skims are calculated. The video summary consists of the calculated dynamic video skims.

### RELATED APPLICATIONS

This patent application is related to:

U.S. patent application Ser. No. ______, titled “Systems and Methods for Generating a Comprehensive User Attention Model”, filed on Nov. 1, 2002, commonly assigned herewith, and which is hereby incorporated by reference.

U.S. application patent Ser. No. ______, titled “Systems and Methods for Automatically Editing a Video”, filed on Nov. 1, 2002, commonly assigned herewith, and which is hereby incorporated by reference.

### TECHNICAL FIELD

The invention pertains to image analysis and processing. In particular, the invention pertains to the analysis of video data to generate a comprehensive user attention model used to analyze video content.

### BACKGROUND

Techniques to generate good video data summaries representative of significant aspects of a given video sequence are greatly desired. For instance, video data summaries can be used for management and access of video data. Additionally, a video summary enables a user to quickly overview a video sequence to determine whether the entire sequence is worth watching. However, to generate a good video summarization typically requires considerable understanding of the semantic content of the video. Despite the significant advances in computer vision, image processing, pattern recognition, and machine learning algorithms, techniques to automate understanding of semantic content of general video are still far beyond the intelligence of today's computing systems.

In general, conventional video summaries are based on static video abstracting and/or dynamic video skimming techniques. A static abstract, also known as a static storyboard, is a collection of salient images or key-frames extracted from the original video sequence. While effective in representing visual content of video, the static key-frames in the static summary typically cannot preserve the time-evolving dynamic nature of video content and loses the audio track, which is an important content channel of video.

A dynamic skimming video summarization consists of a collection of video sub-clips, as well as the corresponding audio selected from the original sequence with the much shortened length. Since a video skimming sequence can preview an entire video, dynamic video skimming is considered to be an important tool for video browsing. Many literatures have addressed this issue. One of the most straightforward approaches is to compress the original video by speeding up the playback. However, the abstract factor is limited in this approach by the limit of playback speed in to keep speech comprehensible.

Another system generates a short synopsis of video by integrating audio, video and textual information. By combining language understanding techniques with visual feature analysis, this system gives reasonable results. However, satisfactory results may not be achievable by such a text-driven approach when speech signals are noisy, which is often the case in life video recording.

In light of the above, and although there have been numerous approaches to generating video summaries, existing techniques for generating video summaries are still far from satisfactory. The direct sampling or low level feature based approaches of static or dynamic video summary generation are often not consistent with human perception. Semantic oriented methods are far from meeting the human requirements because the semantic understanding of video content is beyond current technologies. In addition, textual information may not always be available to drive a summarization. While systems that totally neglect the video audio track are not able to generate impressive results. Furthermore, video summarization algorithms involving large number of summarization rules or over-intensive computation are typically impracticable in many applications.

The following systems and methods address these and other limitations of conventional arrangements and techniques to analyze and summarize video data.

### SUMMARY

Systems and methods to generate a video summary of a video data sequence are described. In one aspect, key-frames of the video data sequence are identified independent of shot boundary detection. A static summary of shots in the video data sequence is then generated based on key-frame importance. For each shot in the static summary of shots, dynamic video skims are calculated. The video summary consists of the calculated dynamic video skims.

### BRIEF DESCRIPTION OF THE DRAWINGS

The detailed description is described with reference to the accompanying figures.

FIG. 1 is a block diagram showing an exemplary computing environment to generate a comprehensive user attention model for attention analysis of a video data sequence.

FIG. 2 shows an exemplary computer-program module framework to generate a comprehensive user attention model for attention analysis of a video data sequence.

FIG. 3 represents a map of motion attention detection with an intensity inductor or I-Map.

FIG. 4 represents a map of motion attention detection with a spatial coherence inductor or Cs-Map.

FIG. 5 represents a map of motion attention detection with a temporal coherence inductor or Ct-Map.

FIG. 6 represents a map of motion attention detection with a saliency map.

FIG. 7 represents a video still or image, wherein a motion attention area is marked by a rectangular box.

FIGS. 8-16 show exemplary aspects of camera attention modeling used to generate a visual attention model. In particular, FIG. 8 shows attention degrees of a camera zooming operation.

FIG. 9 is a graph showing attention degrees of a camera zooming operation by a still.

FIG. 10 is a graph showing attention degrees of a camera panning operation.

FIG. 11 is a graph showing a direction mapping function of a camera panning operation.

FIG. 12 is a graph showing attention degrees of a camera panning operation followed by still.

FIG. 13 is a graph showing attention degrees assumed for camera attention modeling of a still and other types of camera motion.

FIG. 14 is a graph showing attention degrees of camera a zooming operation followed by a panning operation.

FIG. 15 is a graph showing attention degrees of a camera panning operation followed by a zooming operation.

FIG. 16 is a graph showing attention degrees for camera attention modeling of a still followed by a zooming operation.

FIG. 17 is a flow diagram showing an exemplary procedure to generate a comprehensive user attention model for attention analysis of a video data sequence.

FIG. 18 shows exemplary attention model and video summarization data curves, each of which is derived from a video data sequence or from a comprehensive user attention model. The illustrated portions of the data curves represent particular sections of the video data sequence corresponding to its video summary.

FIG. 19 is a flow diagram showing an exemplary procedure to generate a summary of a video data sequence, wherein the video data summary is based on the comprehensive user attention model (data curve) of FIGS. 2 and 18.

FIG. 20 is a block diagram showing an exemplary process to select skim segments of a video data sequence, the skim segments being selected based on key-frames. The key frames are selected via analysis of a comprehensive user attention model generated from the video data sequence.

### DETAILED DESCRIPTION

Overview

The following described systems and methods are directed to generating a summary of a video data sequence, wherein the summary is based on a comprehensive user attention model. As a basic concept, “attention” is considered to be a neurobiological concentration of mental powers upon an object; a close or careful observing or listening, which is the ability or power to concentrate mentally. The computational attention model described below is comprehensive in that it represents such neurobiological concentration by integrating combinations of localized static and dynamic attention models, including different visual, audio, and linguistic analytical algorithms.

To this end, the described comprehensive user attention model is generated by integrating multiple computational attention models, including for example, both static and dynamic attention models are integrated to generate the comprehensive user attention model. Static attention models are typically not utilized for video data analysis due to the dynamic nature of video data. However, in this implementation, static attention models that have been designed to work well with video characteristics are combined with the dynamic (e.g., skimming) attention models to generate the comprehensive user attention model.

The following sections introduce an exemplary operating environment for generating a video summary from a comprehensive user attention model based on a video data sequence. The exemplary operating environment is described in conjunction with exemplary methodologies implemented in a framework of computer-program modules and data flows. The comprehensive user attention model generated via this framework can be used to enable and enhance many video data applications that depend on determining which elements of a video data sequence are more likely than others to attract human attention.

For example, an exemplary video data summarization procedure based on the comprehensive user attention model is described. The video summary is generated via both key-frame extraction and video skimming independent of any semantic understanding of the original video data and without use of substantially complex heuristic rules. Rather, this approach constructs video summaries based on the modeling of how viewers' attentions are attracted by motion, object, audio and language when viewing a video program. The video summarization procedure is illustrative of but one of the many uses of the user attention model for analysis of video content.

An Exemplary Operating Environment

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Program modules generally include routines, programs, objects, components, data structures, etc., that perform particular tasks or implement particular abstract data types.

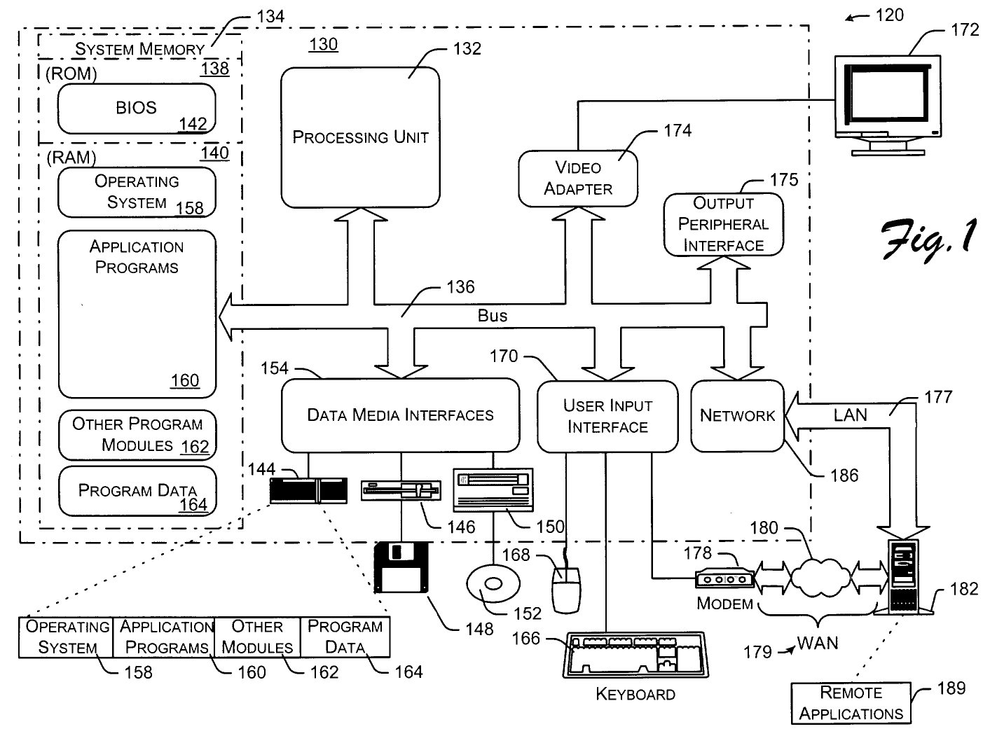

FIG. 1 is a block diagram showing an exemplary computing environment 120 on which the described systems, apparatuses and methods may be implemented. Exemplary computing environment 120 is only one example of a suitable computing environment and is not intended to suggest any limitation as to the scope of use or functionality of systems and methods described herein. Neither should computing environment 120 be interpreted as having any dependency or requirement relating to any one or combination of components illustrated in computing environment 120.

The methods and systems described herein are operational with numerous other general purpose or special purpose computing system environments or configurations. Examples of well known computing systems, environments, and/or configurations that may be suitable include, but are not limited to, including hand-held devices, multi-processor systems, microprocessor based or programmable consumer electronics, network PCs, minicomputers, mainframe computers, portable communication devices, and the like. The invention may also be practiced in distributed computing environments where tasks are performed by remote processing devices that are linked through a communications network. In a distributed computing environment, program modules may be located in both local and remote memory storage devices.

As shown in FIG. 1, computing environment 120 includes a general-purpose computing device in the form of a computer 130. The components of computer 130 may include one or more processors or processing units 132, a system memory 134, and a bus 136 that couples various system components including system memory 134 to processor 132.

Bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 130 typically includes a variety of computer readable media. Such media may be any available media that is accessible by computer 130, and it includes both volatile and non-volatile media, removable and non-removable media. In FIG. 1, system memory 134 includes computer readable media in the form of volatile memory, such as random access memory (RAM) 140, and/or non-volatile memory, such as read only memory (ROM) 138. A basic input/output system (BIOS) 142, containing the basic routines that help to transfer information between elements within computer 130, such as during start-up, is stored in ROM 138. RAM 140 typically contains data and/or program modules that are immediately accessible to and/or presently being operated on by processor 132.

Computer 130 may further include other removable/non-removable, volatile/non-volatile computer storage media. For example, FIG. 1 illustrates a hard disk drive 144 for reading from and writing to a non-removable, non-volatile magnetic media (not shown and typically called a “hard drive”), a magnetic disk drive 146 for reading from and writing to a removable, non-volatile magnetic disk 148 (e.g., a “floppy disk”), and an optical disk drive 150 for reading from or writing to a removable, non-volatile optical disk 152 such as a CD-ROM/R/RW, DVD-ROM/R/RW/+R/RAM or other optical media. Hard disk drive 144, magnetic disk drive 146 and optical disk drive 150 are each connected to bus 136 by one or more interfaces 154.

The drives and associated computer-readable media provide nonvolatile storage of computer readable instructions, data structures, program modules, and other data for computer 130. Although the exemplary environment described herein employs a hard disk, a removable magnetic disk 148 and a removable optical disk 152, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

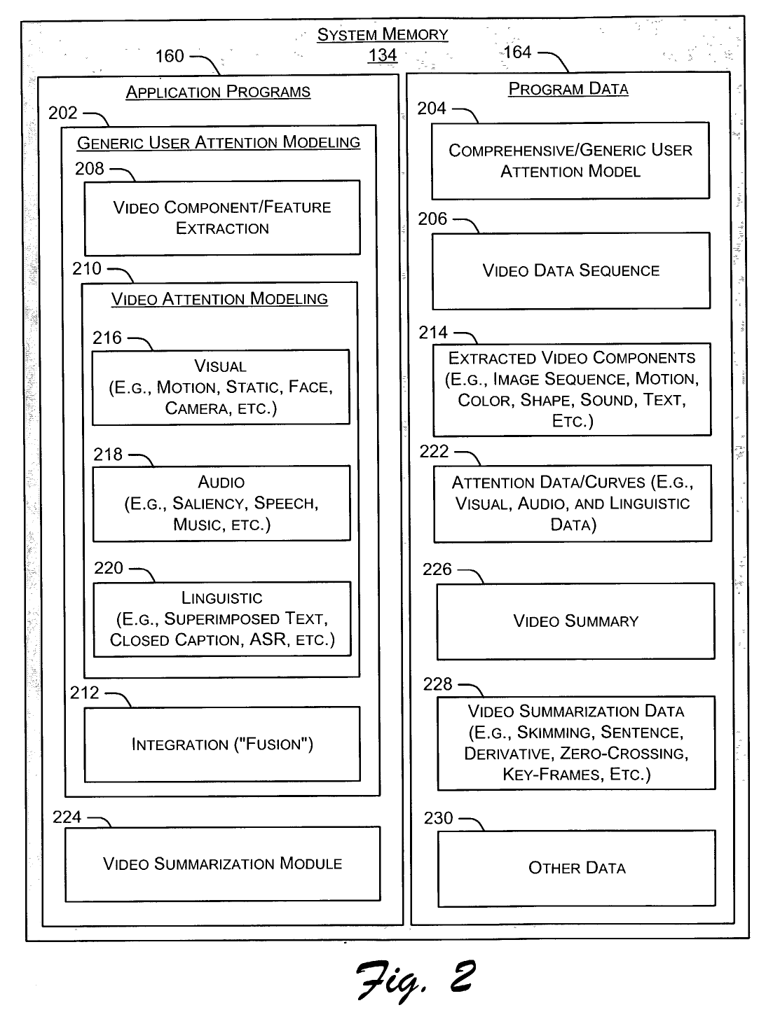

A number of program modules may be stored on the hard disk, magnetic disk 148, optical disk 152, ROM 138, or RAM 140, including, e.g., an operating system 158, one or more application programs 160, other program modules 162, and program data 164. The systems and methods described herein to generate a comprehensive user attention model for analyzing attention in a video data sequence may be implemented within operating system 158, one or more application programs 160, other program modules 162, and/or program data 164. A number of exemplary application programs and program data are described in greater detail below in reference to FIG. 2.

A user may provide commands and information into computer 130 through input devices such as keyboard 166 and pointing device 168 (such as a “mouse”). Other input devices (not shown) may include a microphone, joystick, game pad, satellite dish, serial port, scanner, camera, etc. These and other input devices are connected to the processing unit 132 through a user input interface 170 that is coupled to bus 136, but may be connected by other interface and bus structures, such as a parallel port, game port, or a universal serial bus (USB).

A monitor 172 or other type of display device is also connected to bus 136 via an interface, such as a video adapter 174. In addition to monitor 172, personal computers typically include other peripheral output devices (not shown), such as speakers and printers, which may be connected through output peripheral interface 175.

Computer 130 may operate in a networked environment using logical connections to one or more remote computers, such as a remote computer 182. Remote computer 182 may include many or all of the elements and features described herein relative to computer 130. Logical connections shown in FIG. 1 are a local area network (LAN) 177 and a general wide area network (WAN) 179. Such networking environments are commonplace in offices, enterprise-wide computer networks, intranets, and the Internet.

When used in a LAN networking environment, computer 130 is connected to LAN 177 via network interface or adapter 186. When used in a WAN networking environment, the computer typically includes a modem 178 or other means for establishing communications over WAN 179. Modem 178, which may be internal or external, may be connected to system bus 136 via the user input interface 170 or other appropriate mechanism.

Depicted in FIG. 1, is a specific implementation of a WAN via the Internet. Here, computer 130 employs modem 178 to establish communications with at least one remote computer 182 via the Internet 180.

In a networked environment, program modules depicted relative to computer 130, or portions thereof, may be stored in a remote memory storage device. Thus, e.g., as depicted in FIG. 1, remote application programs 189 may reside on a memory device of remote computer 182. It will be appreciated that the network connections shown and described are exemplary and other means of establishing a communications link between the computers may be used.

FIG. 2 is a block diagram that shows further exemplary aspects of application programs 160 and program data 164 of the exemplary computing device 130 of FIG. 1. In particular, system memory 134 includes, for example, generic user attention modeling module 202. The generic attention modeling module creates comprehensive user attention model 204 from video data sequence 206. The comprehensive attention model is also considered to be a “generic” because it is based on combined characteristics of multiple different attention models, rather than just being based on a single attention model. In light of this, the comprehensive user attention model is often referred to as being generic.

Generic attention modeling module 202 includes video component/feature extraction module 208. The video component extraction module extracts video components 214 from video data sequence 206. The extracted components include, for example, image sequence, audio track, and textual features. From image sequence, motion (object motion and camera motion), color, shape, texture, and/or text region(s) features are determined. Speech, music, and/or other various special sounds are extracted from the video's audio channel. Text-related information is extracted from linguistic data sources such as from closed caption, automatic speech recognition (ASR), and superimposed text data sources.

Video attention modeling module 210 applies various visual, audio, and linguistic attention modeling modules 216-220 to the extracted video features 214 to generate attention data 222. For instance, the visual attention module 216 applies motion, static, face, and/or camera attention models to the extracted features. The audio attention module 218 applies, for example, saliency, speech, and/or music attention models to the extracted features. The linguistic attention module 220 applies, for example, superimposed text, automatic speech recognition, and/or closed caption attention models to the extracted features. Along this line, the generated attention data includes, for example, motion, static, face, camera saliency, speech, music, superimposed text, closed captioned text, and automated speech recognition attention information.

The modeling components that are utilized in video attention modeling module 210 can be considerably customized to apply different combinations of video, audio, and linguistic attention models to extracted video components 214. As long as an attention model (e.g., video, audio, or linguistic) is available to generate the attention data, the attention model can be used in the described system of FIG. 1. These different combinations can be designed to meet multiple video data analysis criteria. In this manner, the video attention modeling module has an extensible configuration.

Integration module 206 of FIG. 2 integrates attention data 222, which represents data from multiple different visual, audio, and linguistic attention models, to generate the comprehensive user attention model 204. In this implementation, the generated attention models are integrated with a linear combination, although other techniques such as user integration and/or learning systems could be used to integrate the data. To integrate the attention data via linear combination, the data for each respective attention model is normalized to

For instance, let A denote the comprehensive user attention model 204 computed as follows:

A=wᵥ·\overline{Mᵥ}+wₐ·\overline{Mₐ}+wₗ·\overline{Mₗ} (1).

In equation (1), wᵥ, wₐ, wₗ are the weights for linear combination, and \overline{Mᵥ}, \overline{Mₐ}, and \overline{Mₗ} are normalized visual, audio, and linguistic attention models, respectively, which are defined as follows:

$$\begin{matrix}{M}_{v} = ( {\sum }_{i = 1}^{p} {w}_{i} \cdot \overline{{M}_{i}} ) \times {( {\overline{M}}_{cm} )}^{{S}_{c m}} & ( 2 ) \\ {M}_{a} = ( {\sum }_{j = 1}^{q} {w}_{j} \cdot \overline{{M}_{j}} ) \times {( {\overline{M}}_{as} )}^{{S}_{as}} & ( 3 ) \\ {M}_{l} = {\sum }_{k = 1}^{r} {w}_{k} \cdot \overline{{M}_{k}} & ( 4 )\end{matrix}$$

where wᵢ, wⱼ, wₖ are weights in visual, audio, and linguistic attention models respectively. If any one model is not weighted, it is set to zero (0). \overline{Mᵢ}, \overline{Mⱼ} and \overline{Mₖ} are the normalized attention model components in each attention model. \overline{M_{cm}} is the normalized camera attention, which is used as visual attention model's magnifier. S_{cm} works as the switch of magnifier. If S_{cm}>=1, the magnifier is open turned on; while S_{cm}=0 the magnifier is closed turned off. The higher the S_{cm} value is, the more powerful the magnifier. Similar to camera attention, \overline{Mₐₛ} is normalized audio saliency attention, which is also used as a magnifier of audio attention. As magnifiers, M_{cm} and Mₐₛ are all normalized to [0˜2]. In the definition of attention models (1˜4), all weights are used to control the user's preference to the corresponding channel. These weights can be adjusted automatically or interactively.

Since the system illustrated by FIGS. 1 and 2 is extensible, any computational visual, audio, or linguistic attention model can be integrated into the framework of the video attention modeling module 210. In this detailed description, modeling methods of some of the most salient audio-visual features are discussed to demonstrate the effectiveness of the described comprehensive user attention model and its application to video summarization. Details of each of the attention modeling methods, with exception of the linguistic attention model, are presented in the following sections. In this implementation, the linguistic attention model(s) are based on one or more known natural language processing techniques, such as key word frequency, central topic detection, and so on.

Visual Attention Modeling

This section describes exemplary operations of visual attention modeling module 216 to generate the visual attention data portion of attention data 222. In an image sequence, there are many visual features, including motion, color, texture, shape, text region, etc. All these features can be classified into two classes: dynamic and static features. Additionally, certain recognizable objects, such as face, will more likely attract human attention. Moreover, camera operations are often used to induce reviewer's attention. In view of this, visual attention models are used to model the visual effects due to motion, static, face, and camera attention, each of which are now described.

### Motion Attention Modeling

The motion attention model is based motion fields extracted from video data sequence 206 (FIG. 2). Motion fields or descriptors include, for example, motion vector fields (MVFs), optical flow fields, macro-blocks (i.e., a block around a pixel in a frame), and so on. For a given frame in a video sequence, we extract the motion field between the current and the next frame and calculate a set of motion characteristics. In this implementation, video sequences, which include audio channels, are stored in a compressed data format such as the MPEG data format. MVFs are readily extracted from MPEG data. The motion attention model of this implementation uses MVFs, although any other motion field or descriptor may also be used to implement the described motion attention model.

If a MVF is considered to be analogous to a retina in an eye, the motion vectors represent a perceptual response of optic nerves. An MVF has three inductors: an Intensity Inductor, a Spatial Coherence Inductor, and a Temporal Coherence Inductor. When the motion vectors in the MVF go through such inductors, they will be transformed into three corresponding maps. These normalized outputs of inductors are fused into a saliency map by linear combination, as discussed below in reference to equation (10). In this way, the attended regions can be detected from saliency map image by image processing methods. Attended region are regions in a video frame that attract viewer attention. Examples of attended regions include the ball in soccer game or basket ball game video, or a racing car in a car racing video.

Three inductors are calculated at each location of macro block MBᵢⱼ. The Intensity Inductor induces motion energy or activity, called motion intensity I, and is computed, namely, as the normalized magnitude of motion vector,

$$I ( i , j ) = \frac{\sqrt{ⅆ {x}_{i , j}^{2} + ⅆ {y}_{i , j}^{2}}}{MaxMag} \qquad ( 5 )$$

where (dxᵢⱼ, dyᵢⱼ) denote two components of motion vector, and MaxMag is the maximum magnitude in a MVF.

The Spatial Coherence Inductor induces the spatial phase consistency of motion vectors. Regions with consistent motion vectors have high probability to be in one moving object. In contrast, regions with inconsistent motion vectors are more likely located at the boundary of objects or in still background. Spatial coherency is measured using a method as described in “A New Perceived Motion based Shot Content Representation”, by Y. F. Ma and H. J. Zhang, published in 2001, and hereby incorporated by reference. First a phase histogram is computed in a spatial window with the size of w×w (pixels) at each location of a macro block. Then, the phase distribution is measured by entropy as follows:

$$\begin{matrix}Cs ( i , j ) = - {\sum }_{t = 1}^{n} {p}_{s} ( t ) Log ( {p}_{s} ( t ) ) & ( 6 ) \\ {p}_{s} ( t ) = \frac{{SH}_{i , j}^{w} ( t )}{{\sum }_{k = 1}^{n} {SH}_{i , j}^{w} ( k )} & ( 7 )\end{matrix}$$

where SH^{w}ᵢⱼ(t) is the spatial phase histogram whose probability distribution function is pₛ(t), and n is the number of histogram bins.

Similar to spatial coherence inductor, temporal coherency is defined as the output of Temporal Coherence Inductor, in a sliding window of size L (frames) along time axis, as:

$$\begin{matrix}Ct ( i , j ) = - {\sum }_{t = 1}^{n} {p}_{t} ( t ) Log ( {p}_{t} ( t ) ) & ( 8 ) \\ {p}_{t} ( t ) = \frac{{TH}_{i , j}^{L} ( t )}{{\sum }_{k = 1}^{n} {TH}_{i , j}^{L} ( k )} & ( 9 )\end{matrix}$$

where TH^{L}ᵢⱼ(t) is the temporal phase histogram whose probability distribution function is pₜ(t), and n is the number of histogram bins.

In this way, motion information from three channels I, Cs, Ct is obtained. In combination this motion information composes a motion perception system. Since the outputs from the three inductors, I, Cs, and Ct, characterize the dynamic spatio-temporal attributes of motion in a particular way, motion attention is defined as:

B=I×Ct×(1−I×Cs) (10)

By (10), the outputs from I, Cs, and Ct channels are integrated into a motion saliency map in which the motion attention areas can be identified precisely.

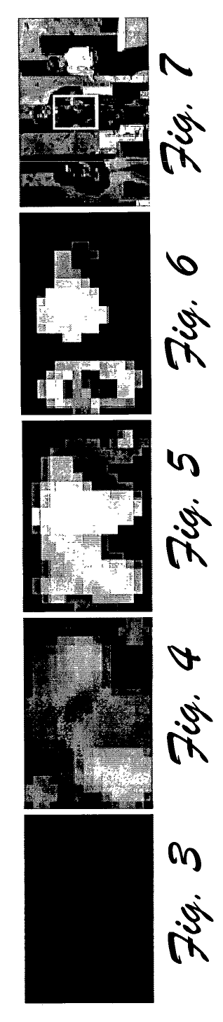

FIGS. 3-6 represent exemplary maps of motion attention detection with respect to areas of motion in an original exemplary image of FIG. 7. In particular: FIG. 3 represents a map of motion attention detection with an I-Map; FIG. 4 represents a map of motion attention detection with a Cs-Map; FIG. 5 represents a map of motion attention detection with a Ct-Map; FIG. 6 represents a map of motion attention detection with a saliency map; and FIG. 7 represents the original image in which a motion attention area is marked by a rectangular box. Note that the saliency map of FIG. 6 precisely detects the areas of motion with respect to the original image of FIG. 7.

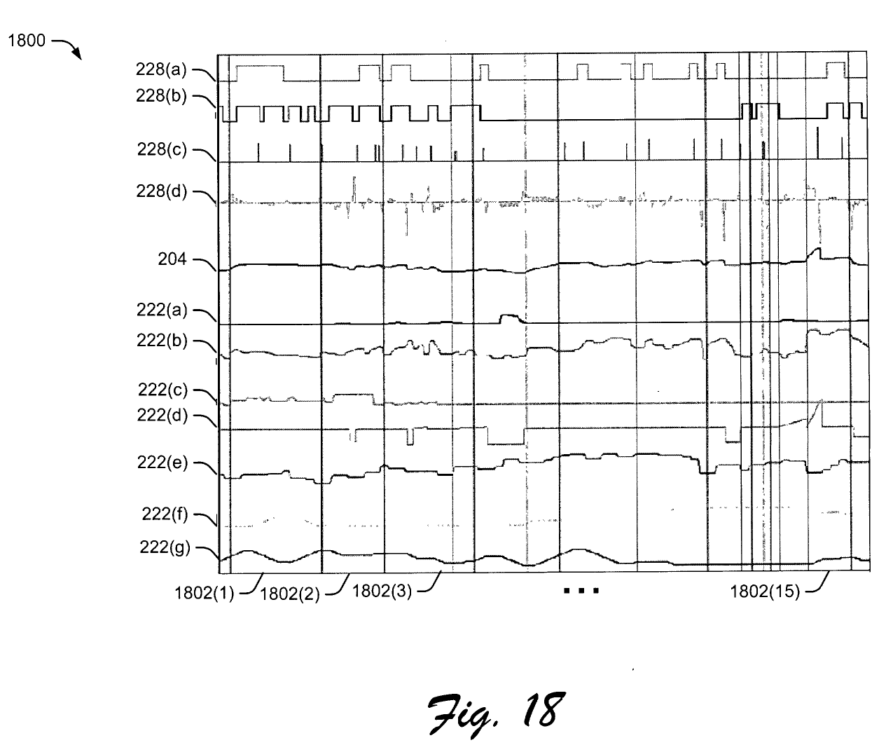

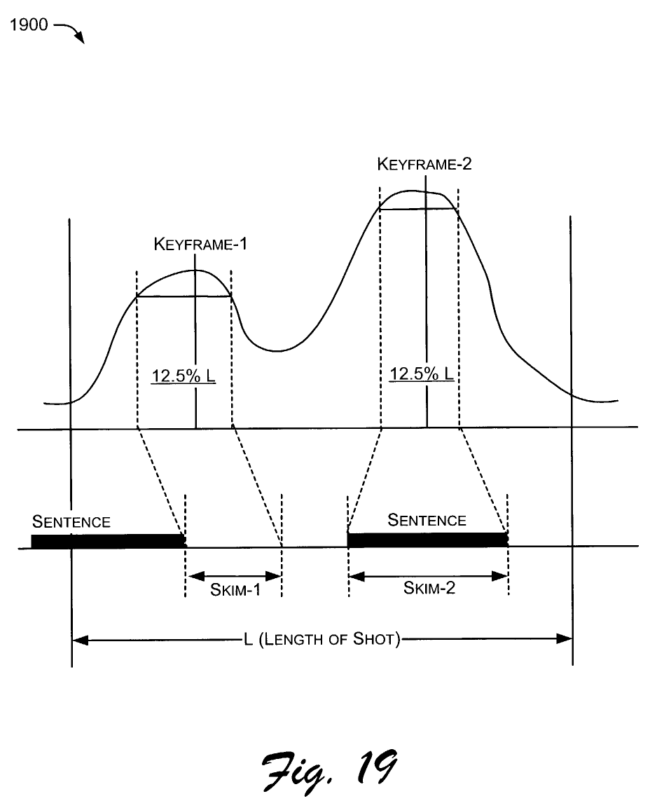

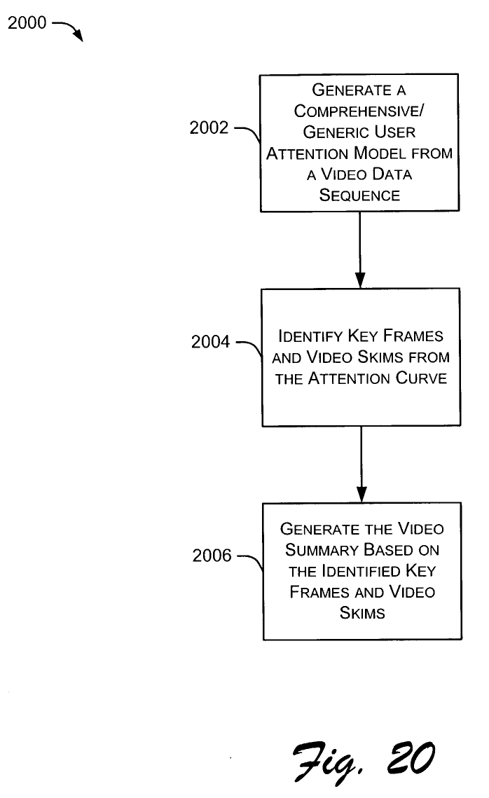

To detect salient motion attention regions as illustrated by the exemplary saliency map of FIG. 6, the following image processing procedures are employed: (a) histogram balance; (b) median filtering; (c) binarization; (d) region growing; and (e) region selection. With the results of motion attention detection, the motion attention model is calculated by accumulating the brightness of the detected motion attention regions in saliency map as follows:

$${M}_{motion} = \frac{( {\sum }_{r ∈ Λ}^{} {\sum }_{q ∈ {Ω}_{r}}^{} {B}_{q} )}{{N}_{MB}} \qquad ( 11 )$$

where B_{q} is the brightness of a macro block in saliency map, Λ is the set of detected areas with motion attention, Ωᵣ denotes the set of macro blocks in each attention area, and N_{MB} is the number of macro blocks in a MVF which is used for the normalization purpose. The Mₘₒₜᵢₒₙ value of each frame in a video sequence then forms a continuous motion attention curve along the time axis. (Data curve 222(e) of FIG. 18 shows an exemplary motion attention curve along the time axis).

### Static Attention Modeling

While motion attention modeling can reveal most of attentions in video, motion attention modeling has limitations. For instance, a static background region may attract human attention; even through there is no motion in the static background. In light of this deficiency, a static attention model is applied to the video data sequence 206 for subsequent integration into the comprehensive user attention model 204.

A saliency-based visual attention model for static scene analysis is described in a paper titled “Computational Modeling of Visual Attention”, by Itti and Koch, published in March 2001, which is hereby incorporated by reference. This work is directed to finding attention focal points with respect to a static image. This work is completely silent with respect to solving any attention model for dynamic scene analysis such as that found in video. In view of this limitation, a static attention model is described to generate a time-serial attention model or curve from individual saliency maps for attention modeling of dynamic scenes by the attention model framework of FIGS. 1 and 2. As described below, the time-serial attention curve consists of multiple binarized static attention models that have been combined/aggregated with respect to time to model attention of a dynamic video sequence.

A saliency map is generated from each frame of video data by the three (3) channel saliency maps to determine color contrasts, intensity contrasts, and orientation contrasts. Techniques to make such determinations are described in “A Model of Saliency-Based Visual Attention for Rapid Scene Analysis” by Itti et al., IEEE Trans. On Pattern Analysis and Machine Intelligence, 1998, hereby incorporated by reference.

Subsequently, a final saliency map is generated by applying portions of the iterative method proposed in “A Comparison of Feature Combination Strategies for Saliency-Based Visual Attention Systems, Itti et al, Proc. Of SPIE Human Vision and Electronic Imaging IV (HVEI'99), San Jose, Calif., Vol. 3644, pp. 473-82, January 1999, hereby incorporated by reference. However, rather than locating human's focus of attention orderly, regions that are most attractive to human attention are detected by binarizing the saliency map. The size, the position and the brightness attributes of attended regions in the binarized or gray saliency map decide the degree of human attention attracted. The binarization threshold is estimated in an adaptive manner according to the mean and the variance of grey level, that is,

T=μ+ασ

where T denotes threshold, μ is mean, and σ is variance. α=3, which is a consistent value.

Accordingly, the static attention model is defined based on the number of attended regions and their position, size and brightness in a binarized saliency map as follows:

$${M}_{static} = \frac{1}{{A}_{frame}} {\sum }_{k = 1}^{N} {\sum }_{( i , j ) ∈ {R}_{k}}^{} {B}_{i , j} \cdot {w}_{pos}^{i , j} \qquad ( 12 )$$

where Bᵢⱼ denotes the brightness of the pixels in saliency regions Rₖ, N denotes the number of saliency regions, A_{frame} is the area of frame, and Wₚₒₛ^{ij} is a normalized Gaussian template with the center located at the center of frame. Since a human usually pays more attention to the region near to the center of a frame, a normalized Gaussian template is used to assign a weight to the position of the saliency regions.

### Face Attention Modeling

A person's face is generally considered to be one of the most salient characteristics of the person. Similarly, a dominant animal's face in a video could also attract viewer's attention. In light of this, it follows that the appearance of dominant faces in video frames will attract a viewers' attention. In view of this, a face attention model is applied to the video data sequence 206 by the visual attention modeling module 216. Data generated as a result is represented via attention data 222, which is ultimately integrated into the comprehensive user attention model 204.

By employing a real time human face detection attention model, the visual attention modeling module 216, for each frame, obtains face animation information. Such information includes the number of faces, and their respective poses, sizes, and positions. A real-time face detection technique is described in “Statistical Learning of Multi-View Face Detection”, by Li et al., Proc. of EVVC 2002; which is hereby incorporated by reference. In this implementation, seven (7) total face poses (with out-plane rotation) can be detected, from the frontal to the profile. The size and position of a face usually reflect the importance of the face.

In view of this, face attention is modeled as

$${M}_{face} = {\sum }_{k = 1}^{N} \frac{{A}_{k}}{{A}_{frame}} \times \frac{{w}_{pos}^{i}}{8} p \qquad ( 13 )$$

where Aₖ denotes the size of k^{th} face in a frame, A_{frame} denotes the area of frame, wₚₒₛⁱ is the weight of position defined in FIG. 4(b), and i∈[0,8] is the index of position. With this face attention model, we may calculate face attention value at each frame to generate face attention curve.

### Camera Attention Modeling

Camera motion is typically utilized to guide viewers' attentions, emphasizing or neglecting certain objects in a segment of video. In view of this, camera motions are also very useful for formulating the comprehensive user attention model 204 for analyzing video data sequence 206.

Generally speaking, if we let the z- axis go through the axes of lens, and be perpendicular to the image plane x-y, camera motion can be classified into the following types: (a) Panning and tilting, resulted from camera rotations around the x- and y-axis, respectively, both referred as panning in this paper; (b) Rolling, resulted from camera rotations around the z-axis; (c) Tracking and booming, resulted from camera displacement along x- and y-axis, respectively, both referred as tracking in this paper; (d) Dollying, resulted from camera displacement along z-axis; (e) Zooming (In/Out), resulted from lens' focus adjustment; and (f) Still.

By using the affine motion estimation, the camera motion type and speed is accurately determined. However, the challenge is how to map these parameters to the effect they have in attracting the viewer's attention. We derive the camera attention model based on some general camera work rules.

First, the attention factors caused by camera motion are quantified to the range of [0˜2]. In the visual attention definition (2), camera motion model is used as a magnifier, which is multiplied with the sum of other visual attention models. A value higher than one (1) means emphasis, while a value smaller than one (1) means neglect. If the value is equal to one (1), the camera does not intend to attract human's attention. If we do not want to consider camera motion in visual attention model, it can be closed by setting the switch coefficient s_{cm} to zero (0).

Then, camera attention is modeled based on the following assumptions:

Zooming and dollying are typically used to emphasize something. The faster the zooming/dollying speed, the more important the content focused is. Usually, zoom-in or dollying forward is used to emphasize the details, while zoom-out or dollying backward is used to emphasize an overview scene. For purposes of this implementation of camera attention modeling, dollying is treated the same as zooming.

If a video producer wants to neglect something, horizontal panning is applied. The faster the speed is, the less important the content is. On the contrary, unless a video producer wants to emphasize something, vertical panning is not used since it bring viewers unstable feeling. The panning along other direction is more seldom used which is usually caused by mistakes.

Other camera motions have no obvious intention and are assigned a value of one (1). In this case, the attention determination is left to other visual attention models.

If the camera motion changes too frequently, it is considered to be random or unstable motion. This case is also modeled as one (1).

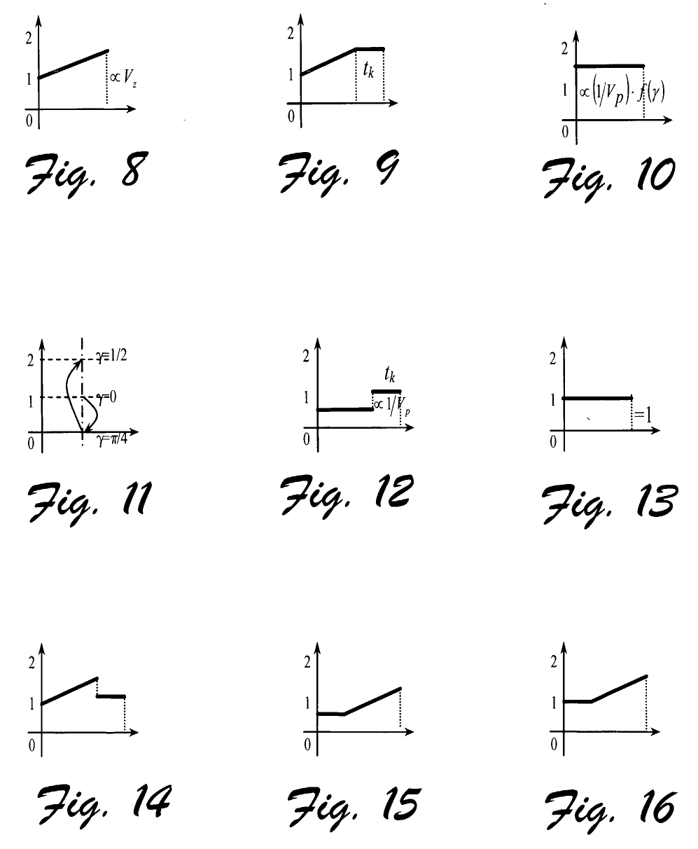

FIGS. 8-16 show exemplary aspects of camera attention modeling used to generate a visual attention data aspects of the attention data 222 of FIG. 2. The assumptions discussed in the immediately preceding paragraph are used to generate the respective camera motion models of FIGS. 8-16.

For example, FIGS. 8 and 9 illustrate an exemplary camera attention model for a camera zooming operation. The model emphasizes the end part of a zooming sequence. This means that the frames generated during the zooming operation are not considered to be very important, and frame importance increases temporally when the camera zooms. As shown in FIG. 8, the attention degree is assigned to one (1) when zooming is started, and the attention degree of the end part of the zooming is direct ratio to the speed of zooming V_{z}. If a camera becomes still after a zooming, the attention degree at the end of the zooming will continue for a certain period of time tₖ, and then return to one (1), as shown in FIG. 9.

FIGS. 10-12 respectively illustrate that the attention degree of panning is determined by two aspects: the speed Vₚ and the direction γ. The attention can be modeled as the product of the inverse of speed and the quantization function of direction as shown in FIG. 10. Taking the first quadrant as an example in FIG. 11, motion direction γ∈[0˜π/2] is mapped to [0˜2] by a subsection function. Zero (0) is assigned to direction γ=π/4, one (1) is assigned to direction γ=0, and two (2) is assigned to direction γ=π/2. The first section is monotonously decreasing while the second section is monotonously increasing. Similar to zooming, if the camera becomes still after a panning, the attention degree will continue for a certain period of time tₖ, and the attention degree will be only inverse ratio to the speed of panning Vₚ as shown in FIG. 12.

FIG. 13 is a graph showing attention degrees assumed for camera attention modeling of still (no motion) and “other types” of camera motion. Note that the model of other types of camera motions is the same as for a still camera, which is/are modeled as a constant value one (1). FIG. 14 is a graph showing attention degrees of camera a zooming operation(s) followed by a panning operation(s). If zooming is followed by a panning, they are modeled independently. However, if other types of motion are followed by a zooming, the start attention degree of zooming is determined by the end of these motions.

FIGS. 15 and 16 show examples of the zooming followed by panning and still respectively. In particular, FIG. 15 is a graph showing attention degrees of a camera panning operation(s) followed by a zooming operation(s). FIG. 16 is a graph showing attention degrees for camera attention modeling of a still followed by a zooming operation, which is also an example of a camera motion attention curve.

Audio Attention Modeling

Audio attention modeling module 218 generates audio attention data, which is represented via attention data 222, for integration into the comprehensive user attention model 204 of FIG. 2. Audio attentions are the important parts of user attention model framework. Speech and music are semantically meaningful for human beings. On the other hand, loud and sudden sound effects typically grab human attention. In light of this, the audio attention data is generated using three (3) audio attention models: audio saliency attention, speech attention, and music attention.

### Audio Saliency Attention Modeling

Many characteristics can be used to represent audio saliency attention model. However, a substantially fundamental characteristic is loudness. Whether the sound is speech, music, or other special sound (such as whistle, applause, laughing, and explosion), people are generally attracted by the louder or sudden sound if they have no subjective intention. Since loudness can be represented by energy, audio saliency attention is modeled based on audio energy. In general, people may pay attention to an audio segment if one of the following cases occurs. One is the audio segment with absolute loud sound, which can be measured by average energy of an audio segment. The other is the loudness of audio segment being suddenly increased or deceased, which is measured by energy peak.

Such sharp increases or decreases are measured by energy peak. Hence, the audio saliency model is defined as:

Mₐₛ=\overline{Eₐ}·\overline{Eₚ} (14)

where \overline{E}ₐ and \overline{E}ₚ are the two components of audio saliency: normalized average energy and normalized energy peak in an audio segment. They are calculated as follows respectively.

\overline{Eₐ}=Eₐᵥᵣ/MaxEₐᵥᵣ (15)

\overline{Eₚ}=Eₚₑₐₖ/MaxEₚₑₐₖ (16)

where Eₐᵥᵣ and Eₚₑₐₖ denote the average energy and energy peak of an audio segment, respectively. MaxEₐᵥᵣ and MaxEₚₑₐₖ are the maximum average energy and energy peak of an entire audio segment corps. A sliding window is used to compute audio saliency along an audio segment. Similar to camera attention, audio saliency attention also plays a role of magnifier in audio attention model.

### Speech and Music Attention Modeling

Besides some special sound effects, such as a laugh, whistle, or explosion, humans typically pay more attention to speech or music because speech and music are important cues of a scene in video. In general, music is used to emphasize the atmosphere of scenes in video. Hence a highlight scene is typically accompanied with music background. On the other hand, textual semantic information is generally conveyed by speech. For example, speech rather than music is generally considered to be more important to a TV news audience.

Additionally, an audience typically pays more attention to salient speech or music segments if they are retrieving video clips with speech or music. The saliency of speech or music can be measured by the ratio of speech or music to other sounds in an audio segment. Music and speech ratio can be calculated with the following steps. First, an audio stream is segmented into sub-segments. Then, a set of features are computed from each sub-segment. The features include mel-frequency cepstral coefficients (MFCCs), short time energy (STE), zero crossing rates (ZCR), sub-band powers distribution, brightness, bandwidth, spectrum flux (SF), linear spectrum pair (LSP) divergence distance, band periodicity (BP), and the pitched ratio (ratio between the number of pitched frames and the total number of frames in a sub-clip). Support vector machine is finally used to classify each audio sub-segment into speech, music, silence, and others.

With the results of classification, speech ratio and music ratio of a sub-segment are computed as follows.

$$\begin{matrix}{M}_{speech} = \frac{{N}_{speech}^{w}}{{N}_{total}^{w}} & ( 17 ) \\ {M}_{music} = \frac{{N}_{music}^{w}}{{N}_{total}^{w}} & ( 18 )\end{matrix}$$

where M_{speech} and M_{music} denote speech attention and music attention model, respectively. N^{w}_{speech} is the number of speech sub-segments, and N^{w}_{music} is the number of music sub-segments. The total number of sub-segments in an audio segment is denoted by N^{w}ₜₒₜₐₗ. Data curves 222(j) and 222(k) of FIG. 18 are respective examples of speech and music attention curves).

The comprehensive user attention model 204 of FIG. 2 provides a new way to model viewer attention in viewing video. In particular, this user attention model identifies patterns of viewer attention in a video data sequence with respect to multiple integrated visual, audio, and linguistic attention model criteria, including static and dynamic video modeling criteria. In light of this, the comprehensive user attention model is a substantially useful tool for many tasks that require computational analysis of a video data sequence. As an exemplary illustration of this substantial utility, a video summarization scheme based on the comprehensive user attention model is now described.

Generating a Video Summary from a Comprehensive User Attention Model

FIG. 18 shows exemplary video summarization and attention model data curves, each of which is derived from a video data sequence. The illustrated portions of the data curves represent particular sections of the video data sequence corresponding to summary of the video data sequence. In particular, video summarization data 228(a)-(d) are obtained via analysis of comprehensive user attention data curve 204, which is generated as described above with respect to FIGS. 1-17. Attention model data curves 222(a)-(g) are generated via analysis of the video data sequence 206, and integrated (via linear combination, see also, equation (10)) by integration module 212 (FIG. 2) to generate the comprehensive user attention curve. In this example, the comprehensive user attention curve is shown immediately below data curve 228(d) and immediately above data curve 222(a).

Summarization data curve 228(a) represents an exemplary skimming curve, wherein the positive pulses represent selected video data sequence skims. Video Sequence summarization curve 228(b) represents exemplary sentence boundaries, wherein the positive pulses symbolize sentences. Video Sequence summarization curve 228(c) represents an exemplary zero-crossing curve. Video Sequence summarization curve 228(d) represents an exemplary derivative curve. These summarization data 228, with the exception of data curve 228(b), are derived from the comprehensive user attention model data curve 204 (FIG. 18), were used to automatically select the particular shots 1802(1)-(15) that comprise the video summary 226 (FIG. 2).

Data curves 228(a)-(d) and 222(a)-(g) are horizontally superimposed in FIG. 18 over a certain number of image shots from a video data sequence. A shot is the basic unit of video sequence, which is a clip recorded between camera started and camera closed. These exemplary shots represent a video summary 226 (FIG. 2) of the video data sequence 206. Vertical lines extending from the top of table 1800 to the bottom of the table represent respective shot boundaries. In other words, each shot is represented with a corresponding column 1802(1)-1802(15) of information.

The actual number of shots 1802 in a particular video summary for a given video data sequence is partially a function of the actual content in the video data sequence (it is also a function of the summarization algorithms described below). In this example, the number of shots comprising the video summary is fifteen (15). Although the specific image shots used to generate this example are not shown, a shot may be based on one or more key-frames (a technique for key-frame selection independent of respective shot boundaries is described below).

As noted above, comprehensive user attention model data curve 204 (FIG. 18) was generated by integrating attention data curves 222(a)-(g). In particular, attention model curve 222(a) represents an exemplary motion attention curve (e.g., generated as described above with respect to the “Motion Attention Modeling” section). Attention model curve 222(b) represents an exemplary static attention curve (e.g., generated as described above with respect to the “Static Attention Modeling” section). Attention model curve 222(c) represents an exemplary face attention curve (e.g., generated as described above with respect to the “Face Attention Modeling” section).

Attention model curve 222(d) represents an exemplary camera attention curve (e.g., generated as described above with respect to the “Camera Attention Modeling” section). Attention data curve 222(e) represents an exemplary audio saliency attention curve (e.g., generated as described above with respect to the “Saliency Attention Modeling” section). Attention data curve 222(f) represents an exemplary speech attention curve (e.g., generated as described above with respect to the “Speech and Music Attention Modeling” section). Attention data curve 222(g) represents an exemplary music attention curve (e.g., generated as described above with respect to the “Speech and Music Attention Modeling” section).

The comprehensive user attention data curve 204 (FIG. 18) provides for extraction of both key-frames and video data sequence skims. In particular, the comprehensive user attention curve is composed of a time series of attention values associated with each frame in a video data sequence 206 (FIG. 2). By performing smoothing and normalizing operations, a number of peaks or crests on the comprehensive user attention model curve are identified. Segments of the video data sequence that correspond to such crests are determined to attract user attention. In view of this, key-frames and skims are extracted based on crest locations of the comprehensive user attention model. To this end, each frame in the video data sequence is assigned an attention value from the comprehensive user attention model.

To determine the precise position of the peak of a crest on the comprehensive user attention model, a derivative curve is computed. An exemplary such derivative curve is data curve 228(d) of FIG. 18. “Zero-crossing points” from positive to negative on the derivative curve indicate locations of wave crest peaks. For instance, referring to derivative curve 228(c), a pin with the height equal to a peak attention value, as compared to other attention values, is used to select a key-frame. In this way, all key-frames in a video sequence are identified independent and without need of any shot boundary detection.

As discussed below, even though key-frames in the video sequence are identified, the video summary may be dynamically or otherwise be restricted in length. Thus, the video summary may need to be shortened to drop or neglect some of the located key-frames. To provide for such length flexibility, a number of key-frame selection criteria are implemented. These criteria incorporate key-frames with higher calculated importance measures into the video summary. Whereas, key-frames with lower calculated importance measures are dropped from the video summary until the required summary length is achieved.

Attention values indicated by the comprehensive user attention model provide key-frame importance measures. For instance, the attention value of a selected key-frame is used as a measure of its importance with respect to other frames in the video data sequence. Based on such a measure, a multi-scale static abstraction is generated by ranking the importance of the key-frames. This means that a can be selected key-frame in a hierarchical way according to the attention valve or curve. In other words, the static abstract can be organized as a hierarchical tree graph, from which multi-scale abstract can be generated. This multi-scale static abstraction is used in conjunction with extracted shots to determine which of the shots and corresponding key-frames will be included in the video summary.

To this end, key-frames between two shot boundaries are used as representative frames of a shot. Shot boundaries can be detected in any of a number of different ways such as automatically or manually. The maximum attention value of the key-frames in a shot is used as the shot's importance indicator. If there is no crest in the comprehensive user attention model that corresponds to a shot, the middle frame of the shot is chosen as a key-frame, and the important value of this shot is assigned to zero (0). If only one key-frame is required for each shot, the key-frame with the maximum attention is selected. Utilizing these importance measures, if the total number of key-frames allowed (e.g., a threshold number of shots indicating a length of the summary) is less than the number of shots in a video shots with lower importance values are neglected.

FIG. 19 is a block diagram 1900 that illustrates exemplary aspects of how to select skim segments from information provided by a comprehensive user attention model. The aggregate or combination of video skims is the video summary. Many approaches can be used to create dynamic video skims based on the comprehensive user attention curve. In this implementation, a shot-based approach to generate video data sequence skims is utilized. This approach is straightforward because it does not use complex heuristic rules to generate the skims. Instead, once a skim ratio is determined (e.g., supplied by a user), skim segments are identified or selected around each key-frame according to the skim ratio within a shot.

To make the audio or sound of a skimmed video smoother, the speech in audio track should not be interrupted within a sentence. So sentence boundary is indispensable information for video skimming. Although it is difficult to fully retrieve each sentence, there are some useful criteria. Such a substantially important criteria is that there usually is a pause or silence duration between sentences. However, due to background sound or noise, an audio clip between two sentences may not be a silence. Thus, an adaptive background sound level detection is used for the purpose of estimating the threshold for pause detection.

Accordingly, in this implementation, speech is segmented into sentences according to the following operations: (a) Adaptive background sound level detection, which is used to set threshold. (b) Pause and non-pause frame identification using energy and ZCR information. (c) Result smoothing based on the minimum pause length and the minimum speech length, respectively. (d) Sentence boundary detection, which is determined by longer pause duration.

Besides attention curves, shot boundary, sentence boundary and key-frames, the following four (4) rules are used to create video skims, as shown in FIG. 19. (a) A segment should not be shorter than the minimum length Lₘᵢₙ. In this implementation, Lₘᵢₙ is set to 30 frames because a segment shorter than 30 frames is generally considered to be not only too short to convey content, but also may create potentially annoying effects. (b) Given a skim ratio, the length of each skim segment is determined by the length of a shot and the number of key-frames in the shot. The number of key-frames in a shot is determined by the number of wave crests on the comprehensive user attention curve. If only one key-frame is used for each shot, the one with maximum attention value is selected.

The skim length of a shot is distributed to each key-frame in this shot evenly. If the average length of skim segment is smaller than Lₘᵢₙ, the key-frame with minimum attention value is removed. Then, the skim length is redistributed to the rest of key-frames. This process is carried out iteratively until the average length is higher than minimum length Lₘᵢₙ. (c) If a skim segment is beyond the shot boundary, it is trimmed at the boundary. (d) The skim segment boundaries must be adjusted according to speech sentence boundaries to avoid splitting speech sentence, either aligning to sentence's boundary like skim-2 in FIG. 19, or evading the sentence's boundary like skim-1 in FIG. 19. In this manner, dynamic skims for the video summary are extracted from the video data sequence according to the wave crests of the comprehensive user attention curve without the need of sophisticated rules.

As illustrated by shot 1802(15) of FIG. 18, although a single key-frame may be used to represent a shot, multiple key-frames may also be determined to represent a shot. In this example, two (2) key-frames are detected in shot 1802(15), as evidenced by wave-peak analysis of the comprehensive user attention curve 204 of the figure. For purposes of discussion, the two key-frames are identified over four (4) respective shots of the original video sequence, which was identified as a “zooming-out” sequence. The zooming-out segment was identified by motion detection algorithm and emphasized by camera attention model curve 222(h), both of which were already discussed above. As a result, this segment 1802(15) is selected to be part of the video skims-see curve 222(a).

An Exemplary Procedure to Generate a Video Summary

FIG. 20 is a flow diagram showing an exemplary procedure 2000 to generate a video summary of a video data sequence. For purposes of discussion, the operations of this procedure are discussed while referring to elements of FIGS. 2, 17, and 18. The video summary is generated from a comprehensive user attention model 204 (FIG. 2) that, in turn, is generated from the video data sequence 206 (FIG. 2). In this implementation, operations of the procedure are performed by video summarization module 224 (FIG. 2).

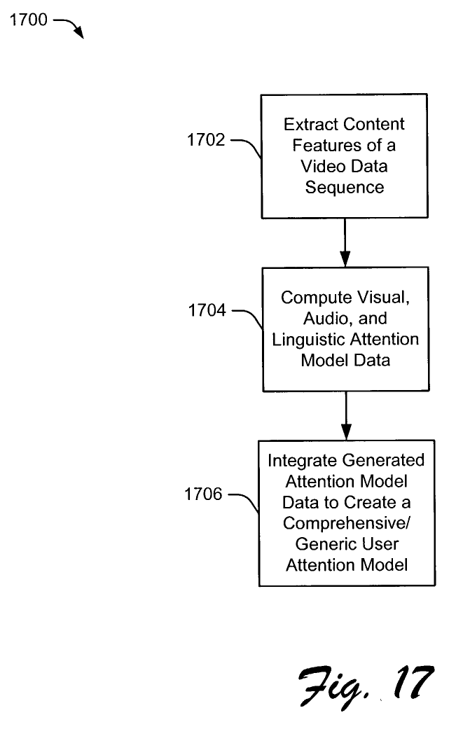

At block 2002, a comprehensive user attention model 204 (FIGS. 2 and 18) of video data sequence 206 is generated. For example, the comprehensive user attention model is generated according to the operations discussed above with respect to blocks 1702-1706 of procedure 1700 (FIG. 17).

At block 2004, key frames and video skims of the input video data sequence are identified utilizing the generated comprehensive user attention model. For example, the video summarization module 224 of FIG. 2 generates a video summarization data 228, including a derivative curve 228(d) and a zero crossing curve 228(c), which are used as discussed above to identify key frames in the video sequence independent of shot boundary identification. The video skims are selected around each identified key frame according to the skim ratio within a shot, as discussed above with respect to FIG. 19.

At block 2004, a video summary is generated from the identified key frames and video skims. For instance, the video summarization module 224 aggregates the identified key frames and video skims to generate the video summary 226. As discussed above, the actual number of shots/key-frames and corresponding dynamic skims may be reduced according to particular importance measure criteria to meet any desired video summary length.

### CONCLUSION

The described systems and methods for generating a video summary from a comprehensive user attention model that, in turn, is based on a video data sequence. Although the systems and methods to generate the video summary have been described in language specific to structural features and methodological operations, the subject matter as defined in the appended claims are not necessarily limited to the specific features or operations described. Rather, the specific features and operations are disclosed as exemplary forms of implementing the claimed subject matter.

1. A method for generating a video summary of a video data sequence, the method comprising:
identifying, independent of shot boundary detection, key-frames of the video data sequence;
generating, based on determined key-frame importance, a static summary of shots from the video data sequence; and
calculating, for each shot in the static summary of shots, one or more dynamic video skims for the shot, an aggregate of calculated dynamic video skims being the video summary.

2. A method as recited in claim 1, wherein identifying the key frames further comprises analyzing attention values provided by a comprehensive user attention model to identify the key frames, the comprehensive user attention model being based at least on integrated visual and audio attention models.

3. A method as recited in claim 1, wherein generating the static summary of shots further comprises:
responsive to determining that there are more key-frames than a threshold number of allowed shots:
assigning each shot an importance value based on maximum key-frame importance in the shot, a shot without a key-frame being assigned a lowest importance value;
dropping shots with importance values that are low as compared to respective importance values of other shots; and
selecting only non-dropped shots for the static summary of shots.

4. A method as recited in claim 1, wherein a shot includes one or more key-frames, and wherein calculating further comprises:
determining a skim ratio for the shot; and
for each of the one or more key-frames in the shot, selecting a skim segment around the key-frame according to the skim ratio.

5. A method as recited in claim 1, wherein calculating further comprises adjusting dynamic skim segment boundaries according to one or more sentence boundaries.

6. A method as recited in claim 1, wherein calculating further comprises, given a skim ratio for the shot, creating each of the one or more dynamic video skims with a respective length that is based on length of the shot and number of key-frames in the shot.

7. A computer-readable memory comprising computer-program instructions executable by a processor to generate a video summary of a video data sequence, the computer-program instructions comprising instructions for:
identifying, independent of shot boundary detection, key-frames of the video data sequence;
generating, based on determined key-frame importance, a static summary of shots from the video data sequence; and
calculating, for each shot in the static summary of shots, one or more dynamic video skims for the shot, an aggregate of calculated dynamic video skims being the video summary.

8. A computer-readable memory comprising computer-program instructions executable by a processor to generate a video summary of a video data sequence, the computer-program instructions comprising instructions for:
identifying key-frames of the video data sequence;
creating a static summary of shots from the video data sequence according to criteria based on relative key-frame importance values; and
calculating one or more dynamic video skims for each shot in the static summary, the one or more dynamic skims being calculated based on a skim ratio for the shot, the video summary being the dynamic skims.

9. A computer-readable medium as recited in claim 8, wherein identifying the key frames is accomplished independent of shot boundary determinations.

10. A method as recited in claim 1, wherein identifying the key frames further comprises analyzing a comprehensive user attention model to identify the key frames, the comprehensive user attention model being based at least on integrated visual and audio attention models.

11. A computer-readable medium as recited in claim 8, wherein the computer-executable instructions for identifying the key frames further comprise instructions for:
generating a derivative data curve from a comprehensive user attention model, the comprehensive user attention model being based at least on integrated visual and audio attention models; and
determining the key frames from respective peak attention values of the derivative data curve.

12. A computer-readable medium as recited in claim 8, wherein the computer-program instructions for creating further comprise instructions for:
evaluating whether a total number of shots in the static summary is more that a desired number of shots;
responsive to identifying that the total number of shots in the static summary is more that the desired number of shots:
determining that a shot is of lower importance than a different shot, the video data sequence comprising the shot and the different shot; and
dropping shots of lower importance as compared to shots of higher importance from the static summary.

13. A computer-readable medium as recited in claim 8, wherein the criteria comprise computer-executable instructions for:
responsive to determining that there are more key-frames than a threshold number of allowed shots:
assigning each shot in the video data sequence an importance value based on maximum key-frame importance in the shot, a shot without a key-frame being assigned a lowest importance value;
dropping shots with importance values that are low as compared to respective importance values of other shots; and
selecting only non-dropped shots for the static summary.

14. A computer-readable medium as recited in claim 8, wherein the instructions for calculating further comprise instructions for adjusting dynamic skim segment boundaries according to a sentence boundary.

15. A computer-readable medium as recited in claim 8, wherein the instructions for calculating further comprise instructions for, given a skim ratio for the shot, creating each of the one or more dynamic video skims with a respective length that is based on length of the shot and number of key-frames in the shot.

16. A computer-readable medium as recited in claim 8, wherein the instructions for calculating further comprise instructions for:
identifying a minimum number of frames for a dynamic skim;
determining that an average frame length of dynamic skims in the shot is less that the minimum number of frames; and
evenly distributing dynamic skim segment boundaries across the shot until an average frame length of dynamic skims in the shot is greater than the minimum number of frames.

17. A computing device to generate a video summary of a video data sequence, the video data sequence comprising multiple shots, the computing device comprising:
a processor; and
a memory coupled to the processor, the memory comprising computer-program instructions executable by the processor for:
identifying key-frames of the video data sequence;
calculating both static and dynamic summarization data from the key-frames; and
generating the video summary from the static and dynamic summarization data.

18. A computing device as recited in claim 17, wherein the static summarization data comprises a multi-scale static shot summary.

19. A computing device as recited in claim 17, wherein the dynamic summarization data comprises multiple dynamic video skims based on a static shot summary.

20. A computing device as recited in claim 17, wherein the comprehensive user attention model is an integrated set of multiple visual, audio, and linguistic attention model data.

21. A computing device as recited in claim 17, wherein the computer-program instructions for calculating further comprise instructions for generating the static summarization data based on relative key-frame importance values determined from a comprehensive user attention model of the video data sequence.

22. A computing device as recited in claim 17, wherein the computer-program instructions for calculating further comprise instructions for generating the dynamic summarization data by adjusting dynamic skim segment boundaries according to sentence boundaries.

23. A computing device as recited in claim 17, wherein the computer-program instructions for calculating further comprise instructions for generating the dynamic summarization data by:
identifying a minimum number of frames for a dynamic skim;
determining that an average frame length of dynamic skims in a shot identified in the static summarization data is less that the minimum number of frames; and
evenly distributing dynamic skim segment boundaries across the shot until an average frame length of dynamic skims in the shot is greater than the minimum number of frames.

24. A computing device to generate a video summary of a video data sequence, the video data sequence comprising multiple shots, the computing device comprising:
means for identifying, independent of shot boundary detection, key-frames of the video data sequence; and
means for calculating both static and dynamic summarization data from the key-frames, the video summary being based on the static and dynamic summarization data.

25. A computing device as recited in claim 24, wherein the static summarization data comprises a static shot summary calculated according to key-frame attention values.

26. A computing device as recited in claim 24, wherein the dynamic summarization data comprises multiple dynamic video skims determined according to shot and sentence boundaries.
